(19) United States
(12) Patent Application Publication
(10) Pub. No.: US 2002/0149591 A1
(43) Pub. Date: Oct. 17, 2002

(54) Storage of multi-media items

(76) Inventors: Renatus Josephus Van Der Vleuten, Eindhoven (NL); Richard Petrus Kleihorst, Eindhoven (NL)

Correspondence Address: Michael E. Marion, c/o PHILIPS ELECTRONICS NORTH AMERICA CORPORATION, Corporate Intellectual Property, 580 White Plains Road, Tarrytown, NY, 10591, US

(21) Appl. No.: 10/101,785

(22) Filed: Mar. 20, 2002

(30) Foreign Application Priority Data
Mar. 26, 2001 (EP) 01201159.9

(51) Int. Cl. G06T 1/60

(52) U.S. Cl. 345/530

(57) ABSTRACT

Storing of at least one multi-media item in a memory is provided, wherein in an automated manner a quality level is determined at which the multi-media item should be stored, which quality level at least partially depends on user preferences. The multi-media item is stored in the memory at the determined quality level. If a plurality of multi-media items is stored in the memory, a plurality of respective quality levels is determined based on the user preferences.

The invention relates to storing of multi-media items in a memory.

The Viewer's Guide for the Philips Personal Video Recorder, TiVo Software Version 1.3, page 34 discloses that a user can choose the video recording quality for the programs to be recorded. The higher quality settings take up more space, and will give fewer hours of recording time. A default recording quality can be set. It is recommended to record several shows at different recording qualities and to decide on a default setting based on the type of programs the user watches most often. When an individual recording is set up, the user can change its quality. Suggested settings are: basic (30 hours of recording time) for animation, medium (18 hours) for daytime talk shows, high (14 hours) for dramas and movies, best (9 hours) for sports and action.

An object of the invention is to provide advantageous use of the available storage capacity. To this end, the invention provides a method of storing, a storage device and a recording apparatus as defined in the independent claims. Advantageous embodiments are defined in the dependent claims.

A first embodiment of the invention provides storing at least one multi-media item in a memory, determining in an automated manner a quality level at which the multi-media item should be stored, which quality level at least partially depends on user preferences, and storing the multi-media item in the memory at the determined quality level. Automatically determining the quality of the multi-media item to be stored based on user preference has the advantage that a user need not indicate per item its desired quality.

In an embodiment of the invention, more preferred multi-media items are stored at a higher quality than less preferred multi-media items. More preferred corresponds to a higher potential user interest and less preferred to a lower potential user interest. The potential user interest is determined from the user preferences. Therefore the desired quality levels are determined automatically by monitoring user preferences. The quality levels can cover the complete range from perfect lossless storage of an item down to completely deleting an item. The quality levels correspond to the (estimated) user's preferences.

In a further embodiment, the storage system usage is also taken into account. In the case the storage capacity is not enough to store a new multi-media item, the quality levels of the previously stored multi-media items and of the multi-media item to be stored are reduced as much as is needed to store all items in the memory. The respective reduced quality levels depend on the respective preference levels of the multi-media items. The more the item is preferred, the higher is its relative quality.

Multi-media items which have already been consumed or outputted once, may be stored at a further reduced quality. This embodiment is especially useful for video items: if a video item has been viewed its potential interest for the user is lower.

When the quality of a given multi-media item reduces below a given (predetermined) threshold, the given multi-media item may be automatically deleted. The threshold may be set as default by the set maker, but may also be set by the user.

Examples of applications are (automatic) video recording (“TiVo box”) or a consumer home audio and/or video “jukebox”. An implementation can be made using the elastic memory concept as proposed in non pre-published European patent application 00200890.2, filed Mar. 13, 2000 (our reference PHNL000110).

WO 00/39707 (our reference PHA 23.590) discloses a video retrieval system that allows a user to quickly and easily select and receive stories of interest from a video stream. The video retrieval system classifies stories and delivers samples of selected stories that match each user's current preference. This document further discloses the use of selective erasure. When a new segment requires an allocation of the recording multi-media, the retrieval system identifies the segments that are on the recording multi-media that have the least correlation with the user's preferences. Instead of replacing the oldest segments with the newest segments, the segments of least potential interest to the user are replaced by the newest segments. The retrieval system also terminates the recording of the newest segment when it determines, based on the classification of the newest segment by the classification system, that the newest segment is of no interest to the user, based on the user preferences.

The determination of user preferences is widely known in the art. Usually, characteristics of multi-media items consumed by the user are stored and a user profile is built based on these characteristics. Characteristics of multi-media items can be determined in a convenient way by monitoring meta data which is sent together with the multi-media items. The meta data indicates characteristics of the multi-media item, such as type of program, etc. See e.g WO 00/39707.

Several aspects of the invention will be apparent from and elucidated with reference to the accompanying drawings.

In the drawings:

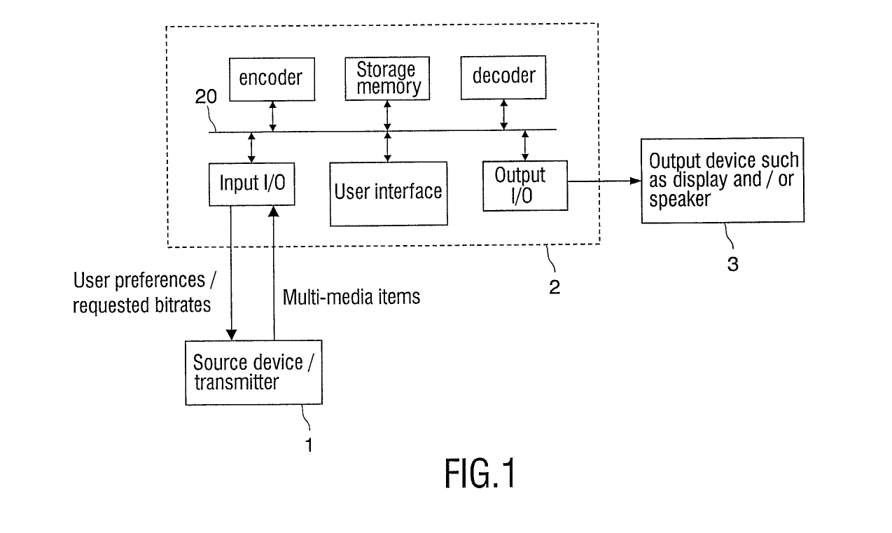

FIG. 1 shows a recording apparatus according to an embodiment of the invention;

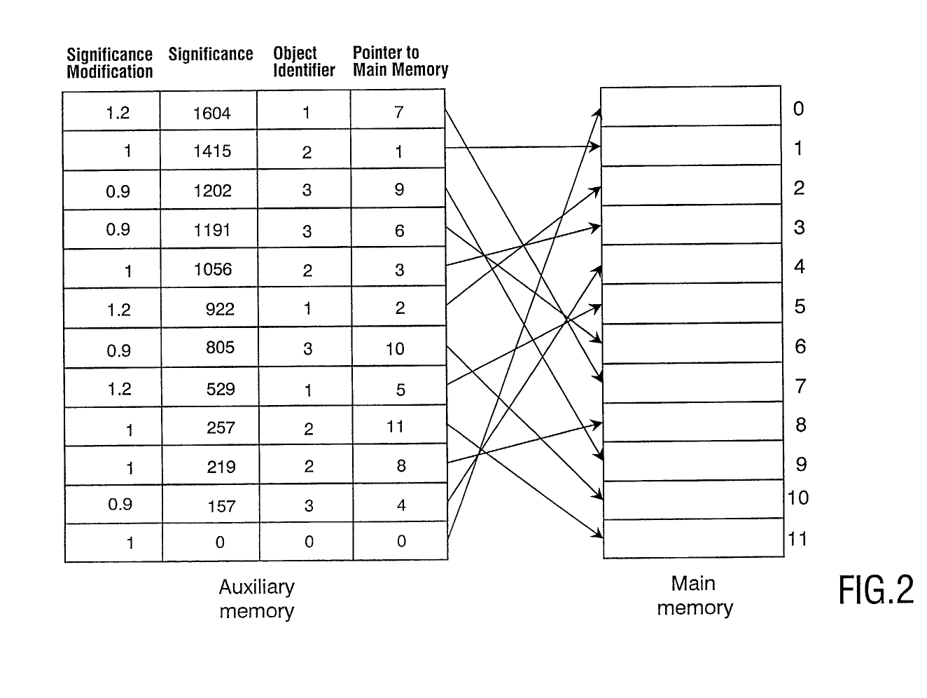

FIG. 2 shows an implementation of the storage memory according to an embodiment of the invention;

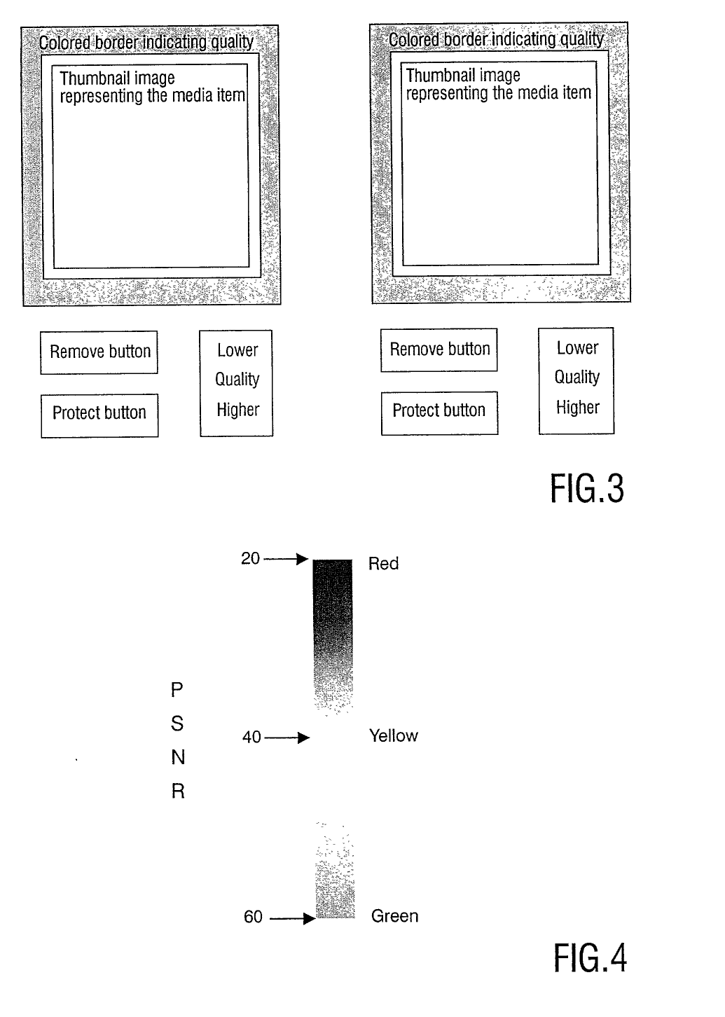

FIG. 3 shows a schematic representation of a user interface for a recording apparatus;

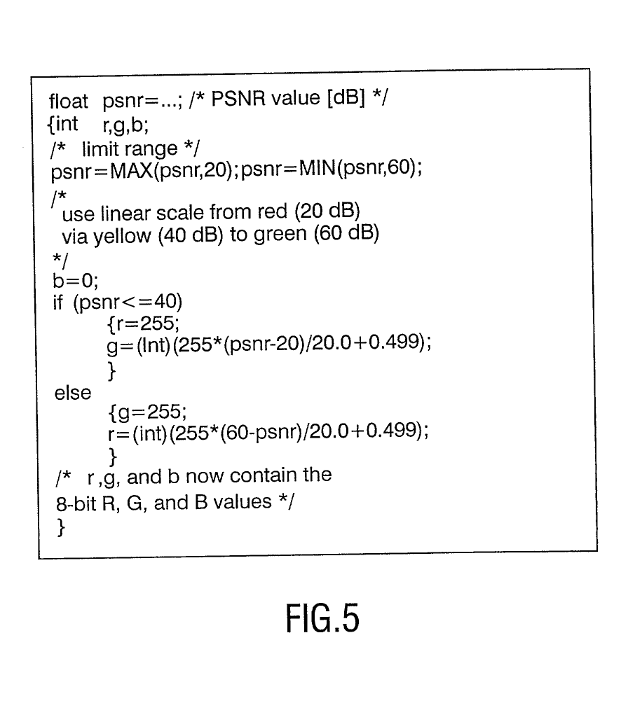

FIG. 4 shows an exemplary mapping of a Peak Signal to Noise Ration (PSNR) value to a color used as a quality indication;

FIG. 5 shows a pseudo-code for converting a PSNR value into a color value (24-bit RGB);

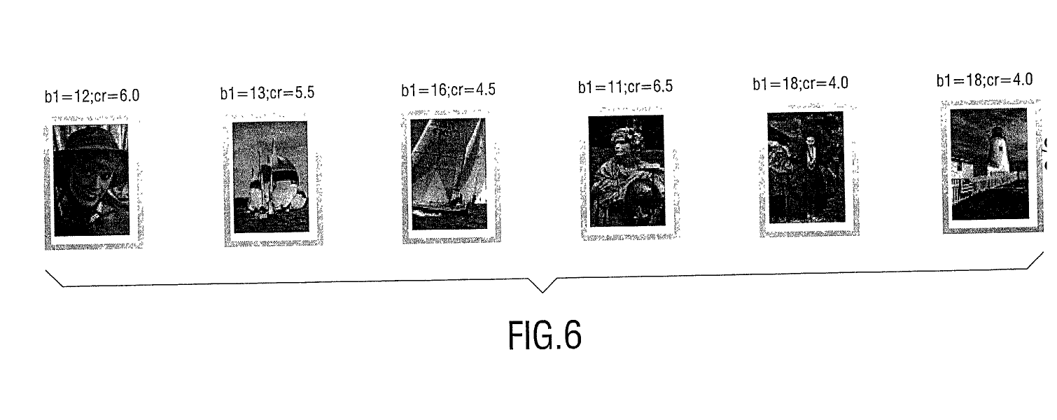

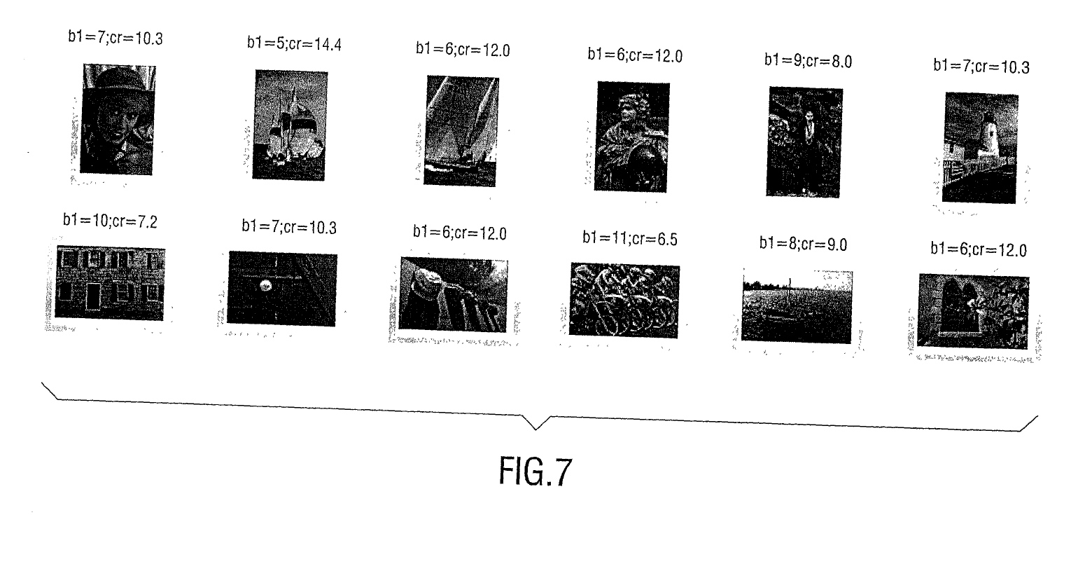

FIGS. 6 and 7 show a representation of a user interface for a recording apparatus after storing of 6 and 12 multi-media items respectively.

The drawings only show those elements that are necessary or useful to understand the invention.

FIG. 1 shows a recording apparatus 2 according to an embodiment of the invention. The recording apparatus comprises an internal data bus 20 to which several elements are coupled, e.g. an encoder, a storage medium, a decoder, an input I/O, a user interface and an output I/O. The input I/O is coupled to a source device 1. The source device 1 furnishes multi-media items to the recording apparatus 2. The source device 2 may be present in the recording apparatus, e.g. as a camera in a digital camera application. Further, the source device may also be a transmitter from which the multi-media items are obtained. The recording apparatus may further be coupled to an output device 3, such as a display and/or speaker. The output device may also be present within the recording apparatus. On the output device the multi-media items may be outputted. Further, the output device can be used as part of the user interface. Control means are further distributed in the recording apparatus over the several elements. It is also possible to use a Central Processing Unit (CPU) to control the several elements and the data transport on the internal data bus 20. The invention may be incorporated in a storage device which may be implemented in an integrated circuit, in that case without a source device, output device and storage memory.

In the following, two implementations of the recording apparatus of FIG. 1 are discussed.

The first implementation is based on the elastic memory concept. The elastic memory (PHNL000110) is a concept for storing a variable number of multi-media items on a storage medium of fixed capacity. When only few items are stored, they are stored at high quality. If more items need to be stored, the quality (i.e., amount of storage space that is occupied) of the already stored items is automatically reduced to make room for the new items. The elastic memory offers each individual user the option to select her/his personally preferred quality-capacity tradeoff. Some users may prefer to store a larger amount of data and are willing to accept a lower data quality. For example, because they own a small-screen television on which visual quality losses are less visible than on a large-screen television.

The elastic memory allows certain multi-media items to be stored at a higher quality than others according an embodiment of the present invention. This can be realized in the elastic memory by changing the measure (quality improvement or distortion reduction or perceptual significance, etc.) that is used to decide the relative importance of each data “block”. For example, the importance values of certain preferred multi-media items might be increased by 20%, when desired by the user. Of course, it is also possible to assign “infinite importance” to a certain item, which prevents any of its data blocks to be overwritten and lets the item be stored at the highest possible quality.

If an elastic memory application contains a large number of items, for example in case of “automatic” video program recording, such as in a “TiVo box”, it is very inconvenient or even impossible for the user to indicate her/his preferred quality for each item, while the user might still prefer to have favorite programs stored at a higher than average quality. According to an embodiment of the present invention, the quality levels correspond to the (estimated) user's preferences. The quality levels can cover the complete range from perfect lossless storage of an item down to completely deleting an item.

The implementation can be done using the elastic memory concept, so only a solution for obtaining the desired quality levels is required. If the data to be stored has been classified, these classifications can be used to set quality levels. This may be done by asking the user to enter preferences for one or more classes. The quality levels may also be obtained by measuring which class of items is most frequently retrieved by the user and increasing the quality levels for more frequently retrieved classes and decreasing them for less frequently retrieved classes. The classification information could, for example, be broadcast together with the program, or as side information in a program guide. Or it could be purchased from a service provider through the cable network or the internet. If no classification information is available, quality levels can be determined by monitoring both the time of storage and the frequency of retrieval. For example, if a television program that is recorded from a certain channel every Wednesday from 20:00-21:00 hours is very frequently retrieved (i.e., watched) by the user, this program could be assigned a higher quality level, so it will be stored at a higher quality the next time it is recorded. In another example, if a user has a “jukebox” containing all her/his audio (from CDs, tapes) and/or video (from DVDs, tapes) content, items that are frequently retrieved may be preserved at a higher quality, in case new items have to be stored, than items that are infrequently retrieved. Furthermore, since newly stored items will probably be more frequently retrieved, they could initially be assigned a higher than average quality level.

A disadvantage of modifying the elastic memory block significance values is that the original values are not preserved. In order to preserve the original values, it is advantageous to add one or more additional fields to the auxiliary memory that store significance modification parameters (such as e.g. a scale factor). See FIG. 2. Such an enhanced elastic memory is applicable in any application in which an elastic memory is used and the significance values may be manipulated.

FIG. 2 shows a main memory and an auxiliary memory to implement the elastic memory concept, with an exemplary content. The main memory and the auxiliary memory may be present in the storage medium of FIG. 1. See for a detailed description of the use of the main memory and the auxiliary memory PHNL00110, which is incorporated by reference herein.

The main memory is divided into N memory parts for storing N data pieces. In this example N=11. The auxiliary memory is typically smaller than the main memory and is used for administrative purposes. The auxiliary memory comprises N records, each record comprising several fields. A first field is a Pointer to Main Memory (P), which comprises a pointer to a location in the main memory 31 that holds the data associated with a given record. A second field is an Object Identifier (I) that comprises information describing the data item to which the data piece stored in the main memory belongs. The object identifier refers to, for example, an image out of a set of images stored by a digital camera. In a practical embodiment the object identifier is zero in case a memory part is not assigned to a data item, e.g. when the memory part is empty. A third field comprises a Significance (S). The S field gives a measure of the significance of the data piece stored in the main memory where the record refers to. The entries in the significance fields are preferably non-negative numbers. The auxiliary memory preferably has the property that the records are sorted on the significance. It is also possible to sort the records in a different manner, e.g. on the identifier to group all data pieces belonging to the same data item. Within the respective groups of data pieces, the data pieces may be sorted on significance.

To add a data item, the data item is coded in the encoder (see FIG. 1) to produce a scalable bit-stream, which is split in to data pieces. The pieces are subsequently processed. The significance measure of each piece is first compared to that of the block with the lowest significance measure currently in the memory. If the significance of the new data piece is lower, it is not stored in the main memory, i.e. it is discarded. When a first piece is not stored, the processing can be stopped because the further data pieces have lower significance than the current data piece (which is a property of a scalable coding mechanism). Further, a scalable bit-stream wherein a data piece is missing in the sequence is not decodable. If the significance is higher, the new data piece is written to the main memory at the position of the current least significant data piece (which is obtained from the last position of the auxiliary memory in case the records are sorted on significance). Thereafter, the last record of the auxiliary memory is replaced by the record data for the new data piece and the records in the auxiliary memory are re-ordered to restore the ordering on significance. It is advantageous to start processing with the most significant data piece of an item (and then with the subsequent data pieces having lower significance), because this is the order in which the data pieces are produced by the scalable coder, and further because these data pieces are not overwritten by blocks belonging to the same item since these are less significant.

To extract a data item, the records in the auxiliary memory are subsequently processed and if the object identifier matches that of the data item to be extracted, the data piece in the main memory pointed to by the record is sent to the (scalable) decoder. Since the auxiliary memory is traversed starting at the highest significance, the data pieces will be extracted at the right order, allowing the decoder to form a progressively better reconstruction.

To delete a data item, the records in the auxiliary memory are subsequently processed and if the object identifier matches that of the data item to be deleted, the significance of the record is set to a (predetermined) value that is lower than any value that can be produced by the encoder, e.g. zero. Preferably, also the identifier is set to a predetermined value, e.g. zero to indicate that the memory part is not assigned to a data piece. The records in the auxiliary memory are then re-ordered to restore the ordering on significance, i.e. such that the records of the lowest significance are placed at the end.

The use of an auxiliary memory is preferred. However, it is also possible to omit the auxiliary memory. In that case the significance of a data piece and an identifier to which data item it belongs should be stored in the main memory. Because pointers to data pieces in order of significance are in this case not available, searching the main memory takes more time. To reduce searching, the data pieces may be sorted in the main memory, at the cost of switching much larger amounts of data. Also a Content Addressable Memory can be used to implement the auxiliary memory, eliminating the need for sorting and searching in the auxiliary memory by a separate processor. Furthermore, more advanced data structures such as heaps or trees, which are generally known, may be used for performing the administrative functions, as an alternative to the preferred auxiliary memory data structure. These alternatives could be advantageous for example in a software implementation (or hardware when sufficient clock cycles are available), especially for a large number of memory parts.

Preferably, some additional information is stored for each data item. The additional information may include name, type of information, color, size, etc. This additional information may be stored in the main memory, e.g. together with the first data piece. Preferably, the additional information is stored in the auxiliary memory, which makes it easier to retrieve this additional information. According to the embodiment of the current invention, a significance modification parameter is stored in the memory as additional information. In FIG. 2 an extra field ‘Significance modification’ has been added to the auxiliary memory. In this example, the significance modification factor is a scale factor. As can be seen, for object (multi-media item) 1 the significance values stored in the significance field is 1.2. This means that the (original) significance values should be multiplied with 1.2 to obtain the current significance values which are used in the elastic memory concept. The significance values of object 2 remain unmodified and the significance values of object 3 are multiplied with 0.9. This means that object 1 is given higher preference than objects 2 and 3. The block significance value used for the elastic memory algorithms is then determined by multiplying the modification factors with the original significance. This means in this example that object 1 will be retained at a higher level than object 2. For example, the second data block of object 2 with original and current significance at 1056 will sooner be overwritten than the second block of item 1, with current significance 1106 (1.2*922), although the original significance of the second block of object 1 is lower than the original significance of the second block of object 2. In this way, easy manipulation of the quality of objects (media items) is possible in the elastic memory concept.

It is further possible to directly store the current (modified) significance values in the significance fields and using those values in the elastic memory algorithms. In this case, the original significance values can be calculated by using the significance modification values.

In fact, any combination of two values out of the three values: original significance value, modified significance value and modification parameter can be stored. When needed, the third value can always be calculated by combining the two stored values. For example, one may use the following relationship:

Modified significance value=original significance value*modification parameter

The further implementation is based on MPEG storage such as currently used in the TiVo box. As already discussed above, the TiVo box allows a user to select a certain desired quality level for recording. Currently, the quality levels are (basic, medium, high, best). This quality selection directly corresponds to a certain bit rate at which the video is encoded using MPEG. Thus, the higher the quality setting, the lower the storage capacity or recording time of the TiVo box. The above-mentioned quality levels correspond to a storage capacity of (30, 18, 14, 9) hours, respectively.

Actually, the levels offered to the user are not true quality levels, since they specify a certain bit rate instead of a quality. The resulting quality still depends on the content of the program that is recorded. In the TiVo manual, it is therefore also suggested to select the “quality” setting based on the program content and to use e.g. the “best” quality setting for sports events or action movies.

To use automatic quality with MPEG storage, ideally a constant quality (e.g. constant quantizer step size) and thus variable bit rate encoding mode should be used. In that case, an average recording quality can be determined and the quality for recording certain programs can be automatically increased or decreased by e.g. 20%, depending on the automatically derived user preferences.

The practical problem with constant quality/variable bit rate recording is of course that it is difficult to use with a fixed storage amount, such as with a hard disk. Therefore, e.g. the TiVo box sets the bit rate of the program instead of the quality. We can automatically do the same: an average bit rate for recording is selected and this bit rate is automatically modified by a certain percentage depending on the automatically determined user preferences. Now the total recording capacity, expressed in hours of video recording, can at each time be exactly determined. An important improvement on this “TiVo-like” method could be to also take into account the program content. If e.g. meta-data is present about the content (like “soap”, “talkshow”, “football”, “thriller”, “action”, etc.) the encoding bit rate may be adjusted to better approach the desired user preferences, by automatically increasing the bit rate for “difficult” content like sports or action. For example, a 20% higher than average desired quality could result in e.g. a 40% higher than average bit rate for a sports program, and only a 5% higher than average bit rate for a talkshow (since content with little movement will automatically get a higher quality because of the constant bit rate recording, even when a higher than average quality is preferred this content could even be recorded at a lower than average bit rate!). When no meta data for the content is available, this can possibly be obtained by analyzing previous recordings. For example, if a user watches a program that is recorded at the same time every day or week, the complexity or “difficulty” (i.e. the resulting program quality at a certain encoder setting) can be analyzed from previous recordings and used to adjust the settings for future recordings.

The automatic adaptation of recording bit rate according to program content (i.e. without the advanced automatic user-preferred quality determination according to the embodiment described above) could also be implemented in the current TiVo system, in order to improve the correspondence between the quality setting selected by the user (basic, medium, high, best) and the actual resulting recording quality. This feature is therefore also applicable to embodiments outside the inventive concept of the current invention.

The invention can be applied in all multi-media storage systems that allow some stored data items to be stored at a higher quality than others, preferably with many possible different quality settings. Examples of applications are (automatic) video recording (“TiVO box”) or a consumer home audio and/or video “jukebox”. The invention can of course also be applied in case of multiple users (accessing for example a remote database or library).

One may store on the HD of the PC items at varying quality (bitrate) in an automated manner depending also on user preferences. The invention is further applicable in transmission and downloading of e.g. MP3 files. Prior to transmission, the user preferences may be consulted by the transmitter in order to determine the bitrate of an item to be transmitted. This has the advantage that no more bits are sent than necessary. Further, if the user preferences can be consulted by the transmitter, the transmitter is able to allocate a limited bandwidth to respective multi-media items, which allocation is based on the user preferences. In this embodiment, items of more potential interest to the user can be allocated more bandwidth at the cost of the bandwidth of a less preferred item in order to provide the more preferred item at a higher quality than the less preferred item. Another possible implementation is that the receiver determines the quality the item should have and thereafter requests the transmitter to deliver the item at the determined quality (see FIG. 1)

The elastic memory (PHNL000110EP.P) allows a variable number of items to be stored on a storage device of fixed capacity. The storage space occupied by each item is automatically adjusted in case subsequently more items have to be stored. This adjustment is accompanied by a corresponding quality reduction. Therefore, it is desirable to provide the user with current information about the media item quality. As an additional feature, the elastic memory also allows different items to be stored at a different quality, according to the user's preferences. This feature must also be supported by the user interface. In the following user interface features related to the quality of the stored media items in a memory-based consumer device will be discussed within the scope of the current invention. These features are also applicable to other embodiments outside the scope of the current invention, in which other embodiments a quality of stored multi-media items may be modified.

There are various useful user-interface features related to the quality of the stored media items in a memory-based consumer device:

1) A color can be used to indicate the quality of individual items (colored background, border, dot etc.) or the overall item quality (guaranteed minimum or average). Advantageously, some representation of the stored item is used together with the quality indication. The color could e.g. range from green for high quality through yellow for medium quality to red for low quality. For images or video, e.g., a linear scale could be used depending on the PSNR (see FIG. 5) or any other quality measure. As a rough indication of the quality, a bitrate of a stored media item may be used.

2) Each individual stored item can be assigned a “protect button”. As long as this button is active, the associated media item is protected from any quality loss when subsequently more items are stored. This can be used, e.g. in a camera application to protect a picture that the user likes very much. This can be implemented by temporarily (while the button is active) replacing the elastic memory block significance values by a value that is larger than any value that can otherwise occur.

3) Each individual stored item can be assigned a “higher/lower than average quality” button or setting (i.e. allowing multiple values) which will influence the item quality when subsequently more items are stored. This option can also be used as a “soft-delete” function: when the user does not like a certain item, it may be stored at a lower than average quality; under certain circumstances, it might even be automatically deleted. This feature can be implemented, e.g., by scaling (multiplying by a constant) the elastic memory block significance values for the items according to the quality setting.

4) In addition to the previous option that influences the quality of already stored items, it is also desirable to be able to influence the quality at which the next item will be stored, e.g. using a “record/store next item at higher than average quality” button or setting. This can be implemented by scaling the item's block significance values before storing them.

5) A user may not be interested in constantly monitoring the item quality, but only be interested in maintaining a certain guaranteed item quality (which he/she can preset/preselect). In that case, an “audio (e.g. a beep) and/or visual (e.g. a blinking light) quality warning signal” may be given when the item quality goes below the predetermined threshold, or, alternatively, is expected to go below this threshold after storing a certain additional number of items (for example two more pictures).

Some of the above features are implemented by modifying the elastic memory block significance values as discussed above.

The stored items can be images, but e.g. also audio or video items that may also be represented by thumbnails (e.g. the CD/DVD cover print) and/or track names and/or individual scene thumbnails, in particular of key frames.

An example of a possible user interface for a digital still image camera is shown in FIGS. 4, 6 and 7. FIG. 4 shows a schematic representation of the user interface for two images. The images that are shown are just the thumbnails; the full image is displayed if the user clicks on one of the thumbnails. An image can be deleted by clicking on the Remove button below its thumbnail. The numbers above the image thumbnails indicate the number of memory blocks (bl) allocated to the image, as well as its compression ratio (cr) (compared to the 24 bit/pixel original). This information would of course normally not be shown to the user. The image quality is indicated by the color of the box around each thumbnail. This color varies continuously from green, for very high image quality (60 dB PSNR), through yellow (40 dB PSNR) to red, for very poor image quality (20 dB PSNR); see FIG. 5. The quality feedback may help the user to decide whether to take more pictures. In an elastic memory implementation all images have about the same quality and more storage space is assigned to the complex images than to the less complex images. In an embodiment according to the present invention, more preferred images have a higher quality than less preferred images.

A multi-media item may be an image, an audio item, a video item or a combination of these, in particular as (part of) a program item, etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, storing of at least one multi-media item in a memory is provided, wherein in an automated manner a quality level is determined at which the multi-media item should be stored, which quality level at least partially depends on user preferences. The multi-media item is stored in the memory at the determined quality level. If a plurality of multi-media items is stored in the memory, a plurality of respective quality levels is determined based on the user preferences.

1. A method of storing at least one multi-media item in a memory, the method comprising:
determining in an automated manner a quality level at which the multi-media item should be stored, which quality level at least partially depends on user preferences, and
storing the multi-media item in the memory at the determined quality level.

2. A method as claimed in claim 1, wherein the quality is progressively related to a potential user interest, which potential user interest is based on the user preferences.

3. A method as claimed in claim 1, wherein the quality is proportional to a potential user interest, which potential user interest is based on the user preferences.

4. A method as claimed in claim 1, wherein a plurality of multi-media items is stored in the memory and a plurality of respective quality levels is determined based on the user preferences.

5. A method as claimed in claim 1, the method further comprising:
evaluating a quality level of at least one multi-media item which has previously been stored in the memory; and
determining the quality at which the multi-media item should be stored based on the quality level of the at least one previously stored multi-media item and the user preferences.

6. A method as claimed in claim 5, wherein in the case that a capacity of the storage medium does not suffice to store the multi-media item at the determined quality, the quality of the previously stored multi-media item and the quality of the multi-media item to be stored are reduced taking into account the user preferences.

7. A method as claimed in claim 1, wherein a given quality corresponds to a given bit-rate and wherein the multi-media item is stored at a determined bitrate which corresponds with the determined quality.

8. A method as claimed in claim 7, wherein an average bit rate for recording is selected and this bit rate is automatically modified by a certain percentage depending on the user preferences to obtain the determined bitrate.

9. A method as claimed in claim 7 or 9, wherein the determined bitrate is adapted to take into account the content of the multi-media item, in particular a dependence of the bitrate on the content for a given quality.

10. A method of providing a user interface for a recording apparatus, which recording apparatus is capable of storing multi-media items at varying quality in a storage memory, the method comprising using a color to indicate the quality of at least one multi-media item available on the storage medium, which color corresponds to a quality of the multi-media item.

11. A method as claimed in claim 10, wherein the colored quality indication is displayed together with a representation of the stored item.

12. Device for storing at least one multi-media item in a memory, the device comprising:
means for determining in an automated manner a quality level at which the multi-media item should be stored, which quality level at least partially depends on user preferences, and
means for storing the multi-media item in the memory at the determined quality level.

13. Device for providing a user interface for a recording apparatus, which recording apparatus is capable of storing multi-media items at varying quality in a storage memory, the device comprising means for displaying a color to indicate the quality of at least one multi-media item available on the storage medium, which color corresponds to a quality of the multi-media item.

14. Recording apparatus comprising a storage memory on which multi-media items can be stored and a storage device according to claim 12 or 13.

15. A storage memory having stored thereon multi-media items, which multi-media items have been divided into successive data pieces of decreasing significance, which data pieces have been stored in respective memory parts of the storage medium, wherein on the storage medium at least two of the following parameters are available: an indication of a current significance of each data piece, an indication of an original significance and a significance modification parameter.

16. A method of storing at least one multi-media item in a memory, the method comprising:
adapting in an automated manner a recording bit-rate at which the multi-media item is stored, in dependence on the item content and a quality setting selected by a user, and
storing the multi-media item in the memory at the adapted recording bit-rate.

17. A device for storing at least one multi-media item in a memory, the device comprising:
means for adapting in an automated manner a recording bit-rate at which the multi-media item is stored, in dependence on the item content and a quality setting selected by a user, and
means for storing the multi-media item in the memory at the adapted recording bit-rate.
